(19) United States
(12) Patent Application Publication
(10) Pub. No.: US 2014/0240274 A1
(43) Pub. Date: Aug. 28, 2014

(54) Single-layer capacitive touch panel for multi-point sensing

(71) Applicant: INPUTEK INC., Hisnchu County (TW)

(72) Inventors: Chang Kuang CHUNG, Hsinchu County (TW); Sheng Chang KUO, Hsinchu County (TW)

(73) Assignee: INPUTEK INC., Hsinchu County (TW)

(21) Appl. No.: 13/779,233

(22) Filed: Feb. 27, 2013

(51) Int. Cl. G06F 3/044

(52) U.S. Cl. CPC G06F 3/044
USPC 345/174

(57) ABSTRACT

The present invention provides a single-layer capacitive touch panel for multi-point sensing. The capacitive touch panel includes a single patterned touch-sensing layer. When a touch occurs at a certain point on the capacitive touch panel, the generated coupling signal passes through the patterned touch-sensing layer along a determined path so that the coupling signal and thus the location of the certain touch point can be precisely detected. At least two touch points on the capacitive touch panel can be simultaneously detected by enforcing asynchronous scanning at four detecting points at four corners of the capacitive touch panel. Additionally, the single-layer capacitive touch panel can be partitioned into N blocks so as to accomplish the simultaneous sensing of 2×N touch points on the touch panel.

### BACKGROUND OF THE INVENTION

1. Field of the Invention

The present invention generally relates to a capacitive touch panel, and more particularly, to a single-layer capacitive touch panel capable of simultaneously sensing multiple points on the capacitive touch panel.

2. Description of the Prior Art

Conventional projected capacitive touch panels are usually constructed by two layers of ITO (Indium Tin Oxide) thin films. In such a two-layer capacitive touch panel, horizontal sensor elements and their interconnecting sensor traces are disposed on the upper ITO layer; and vertical sensor elements and their interconnecting sensor traces are disposed on the lower ITO layer. Then the upper and lower ITO layers are aligned and combined together and further covered with a cover lens for protection. The fabrication process of such conventional projected capacitive touch panels involves at least two lamination processes including film to glass lamination and glass to glass lamination, both of which require high level techniques for lamination. Any of the lamination processes cannot fail during the fabrication process, otherwise all the other related processes may need to be redone. Thus, the cost of conventional projected capacitive touch panels is very high because of low lamination yield rate and the use of multi-layer materials. In order to simplify the fabrication process and reduce the manufacture cost, using only a single touch-sensing layer (e.g. a single ITO layer) to construct a capacitive touch panel may be a feasible solution and thus an objective of the present invention.

In addition, multi-point touch panels have become a tendency of the future touch panels. Recently some multi-point touch panels have been already disclosed. But those disclosed multi-point sensing techniques may require complicated control circuits and cannot be implemented on single-layer capacitive touch panels. Therefore, the present invention will be aimed at realizing the capability of multi-point sensing on a single-layer capacitive touch panel.

### SUMMARY OF THE INVENTION

The present invention provides a single-layer capacitive touch panel for multi-point sensing. Firstly, a desired pattern can be formed on a single touch-sensing layer such as ITO glass layer or ITO film by an etching process to the touch-sensing layer. The pattern on the touch sensing layer is set to make the generated coupling signal pass through the patterned touch-sensing layer along a uniquely determined path when a touch occurs at a certain point on the capacitive touch panel so that the coupling signal and thus the location of the certain touch point can be precisely detected.

On the single-layer capacitive touch panel, at least two touch points can be simultaneously detected by enforcing asynchronous scanning at four detecting points respectively disposed at four corners of the capacitive touch panel. Additionally, in order to accomplish the simultaneous sensing of even more touch points, the single-layer capacitive touch panel can be partitioned into N blocks each of which realizes two-point detection. Thereby the entire capacitive touch panel can be able to simultaneously detect 2×N touch points on the touch panel.

### BRIEF DESCRIPTION OF THE DRAWINGS

The foregoing aspects and many of the attendant advantages of the present invention will become readily appreciated by reference to the following detailed description, when taken in conjunction with the accompanying drawings which are schematic and not to scale, and in which like reference numerals refer to like elements, wherein:

FIG. 1 schematically shows a top view of a single-layer capacitive touch panel according to the present invention;

FIG. 2 schematically illustrates the multi-point sensing by use of the single-layer capacitive touch panel according to the present invention;

FIG. 3 schematically illustrates the asynchronous clock signals applied to different detecting points on the capacitive touch panel according to the present invention;

FIG. 4 schematically illustrates a top view of a single-layer capacitive touch panel with a first type of panel partition for multi-point sensing according to a first embodiment of the present invention;

FIG. 5 schematically illustrates a top view of a single-layer capacitive touch panel with a second type of panel partition for multi-point sensing according to a second embodiment of the present invention; and

FIG. 6 schematically illustrates a top view of a single-layer capacitive touch panel with a third type of panel partition for multi-point sensing according to a third embodiment of the present invention.

### DETAIL DESCRIPTIONS OF THE INVENTION

This section illustrates aspects of the invention and points out certain preferred embodiments of those aspects. This section is not intended to be exhaustive, but rather to teach the person of skill in the art to more fully appreciate other possible aspects and equivalents of the invention and hence the scope of the invention as set forth in the appended claims.

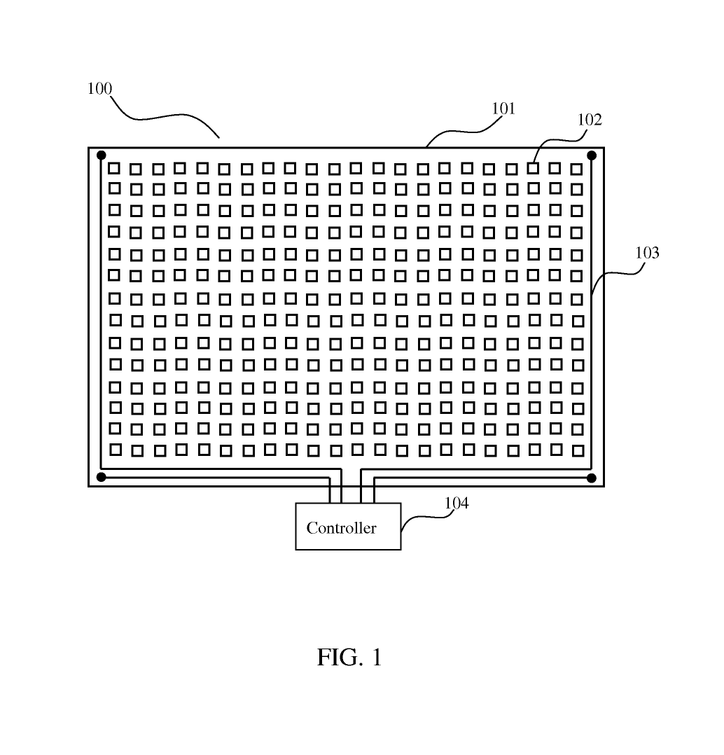

Referring to FIG. 1, a top view of a single-layer capacitive touch panel 100 according to an embodiment of the present invention is schematically illustrated. The capacitive touch panel 100 contains a single touch-sensing layer 101 for sensing touches on the touch panel 100. The touch-sensing layer 101 can be a transparent ITO layer on which a desired pattern is formed by applying an etching process to the ITO layer. It is well known that a surface capacitive touch panel also utilizes a single ITO layer as a touch-sensing layer. However, the ITO layer of the surface capacitive touch panel cannot be etched and even a small piece of the ITO layer being broken will disturb the proper operation of the surface capacitive touch panel since a constant electric field needs to be uniformly distributed on the ITO layer to ensure the proper operation of the surface capacitive touch panel. In contrast, the present invention makes use of a patterned touch-sensing layer. As illustrated in FIG. 1, the portions that are represented by squares 102 are etched out of the touch-sensing layer 101 by applying an appropriate mask on the touch-sensing layer 101 in the etching process. With such a mesh pattern formed on the touch-sensing layer 101, when a touch occurs at a certain point on the capacitive touch panel 100, the generated coupling signal passes through the patterned touch-sensing layer 101 along a determined path so that the coupling signal and thus the location of the certain touch point can be precisely detected. Herein, in order to facilitate precise touch detection, any mesh pattern may be generated by applying an appropriate mask for etching the touch-sensing layer 101. The pattern as shown in FIG. 1 is only used in a preferred embodiment, and the squares 102 may be replaced by any other shapes such as circles or octagons in other embodiments of the present invention. More generally, any kinds of predetermined patterns can be formed on the touch-sensing layer 101 by etching or any other processing so as to increase the resistance distributed on the touch-sensing layer 101 and thus improve the sensitivity of touch detection.

In addition to the touch-sensing layer 101, the capacitive touch panel 100 further comprises four sensing traces 103 and a controller 104. There are four detecting points that are respectively positioned at four corners of the capacitive touch panel 100. The four sensing traces 103 respectively correspond to the four detecting points and are responsible for transferring the generated sensing signals from the four detecting points to the controller 104 when certain touches occur on the touch-sensing layer 101. Then these sensing signals are analyzed and calculated in the controller 104 so as to determine the locations of the touches on the capacitive touch panel 100. In an embodiment of the present invention, the sensing traces 103 may be preferably formed together with the patterned touch-sensing layer 101 in a same process or may be formed by a separate process.

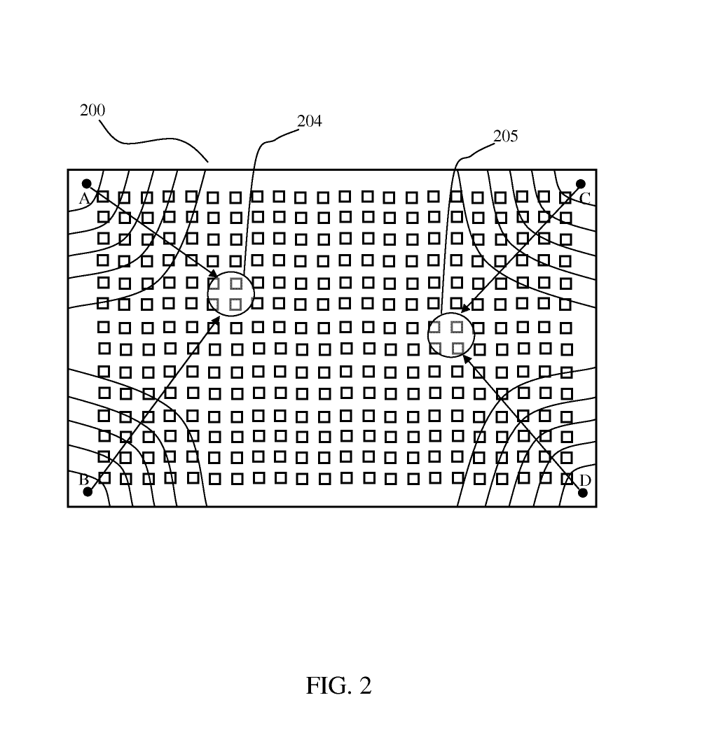

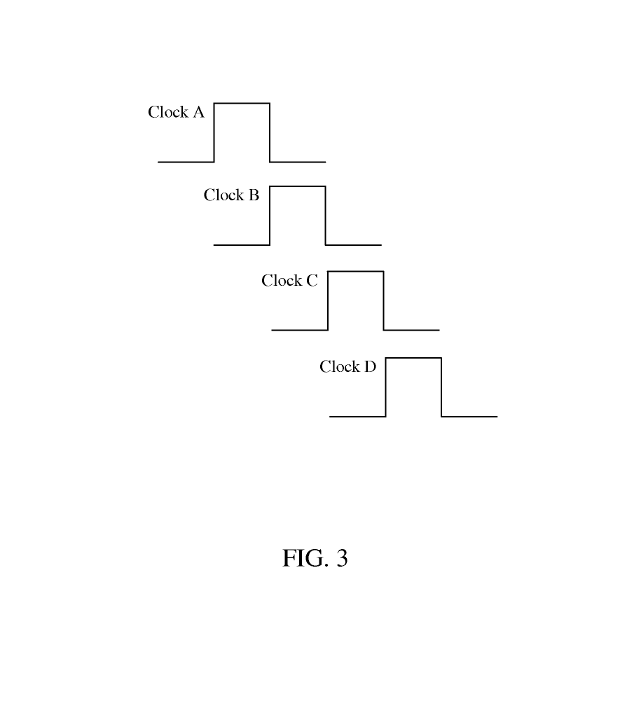

According to the present invention, at least two-point sensing can be accomplished by enforcing asynchronous scanning at four detecting points at four corners of a capacitive touch panel. FIG. 2 illustrates the basic concept of detecting multiple touch points on the single-layer capacitive touch panel 200 according to the present invention. Four detecting points A, B, C, D are respectively positioned at four corners of the capacitive touch panel 200. Having a predetermined pattern formed on the touch-sensing layer of the capacitive touch panel 200, when two fingers are simultaneously touching the capacitive touch panel 200 at two touch points respectively referred to as 204, 205, a uniquely determined charging/discharging path with high resistance is built up between each touch point and each detecting point. For illustration, the resistances of the paths between the first touch point 204 and the detecting points A, B, C, D are represented by R11, R12, R13, and R14 respectively, the resistances of the paths between the second touch point 205 and the detecting points A, B, C, D are represented by R21, R22, R23, and R24 respectively, and the body capacitance of a person touching the capacitive touch panel 200 is represented by C. In the present invention, for the purpose of reducing signal interference between different detecting points, asynchronous clock signals as schematically shown in FIG. 3 are applied to scan the signal changes at the four detecting points. Therefore, a clock signal is firstly applied to scan the voltage change at the detecting point A for a predefined period of time, and the voltage change is communicated to a controller for calculating the position of the touch point. In this case, the amount of the voltage change is determined by the RC time constant R11*C+R21*C, and mostly determined by the RC time constant R11*C as the first touch point 204 is more close to the detecting point A than the second point 205. After scanning the detecting point A, the clock signal is switched to the detecting point B, and similarly the voltage change mostly determined by the RC time constant R12*C is communicated to the controller. Next, the detecting points C and D are successively scanned for the same predefined period of time as the detecting points A and B, and the voltage change at the detecting point C mostly determined by the RC time constant R23*C and the voltage change at the detecting point D mostly determined by the RC time constant R24*C are communicated to the controller. Then, in the controller, the position of the touch point 204 can be calculated out in accordance with the detected voltage changes at the detecting points A and B over the predefined period of time, and the position of the touch point 205 can be calculated out in accordance with the detected voltage changes at the detecting points C and D over the predefined period of time. In general, the detecting points A, B are responsible for detecting the first touch point 204 that is close to the two detecting points A, B and the other two detecting points C, D assist the detection of the first touch point 204; likewise, the detecting points C, D are responsible for detecting the capacitance change caused by the second touch point 205 that is close to the two detecting points C, D, and the other two detecting points A, B assist the detection of the second touch point 205. In this way, two touch points on the single-layer capacitive touch panel 200 can be detected at the same time. The high resistance of the patterned touch-sensing layer and the asynchronous scanning for the four detecting points increase the sensitivity of touch sensing and ensure the feasibility of multi-point sensing.

As illustrated in the foregoing description, the present invention can simultaneously detect two touch points on a capacitive touch panel by scanning four detecting points respectively at four corners of the capacitive touch panel. Compared to conventional projected capacitive touch panels that are made up of an N×M matrix of rows and columns of conductive elements and (N+M) sensing traces, the present invention has a much simpler configuration and easier control mechanism.

Furthermore, in order to be capable of simultaneously detecting even more touch points on the capacitive touch panel, the concept of panel partition is introduced in the present invention. That is, the capacitive touch panel can be partitioned into N blocks each of which can realize two-point detection according to the above illustration. Thus the entire touch panel can be able to simultaneously detect 2×N touch points on the touch panel.

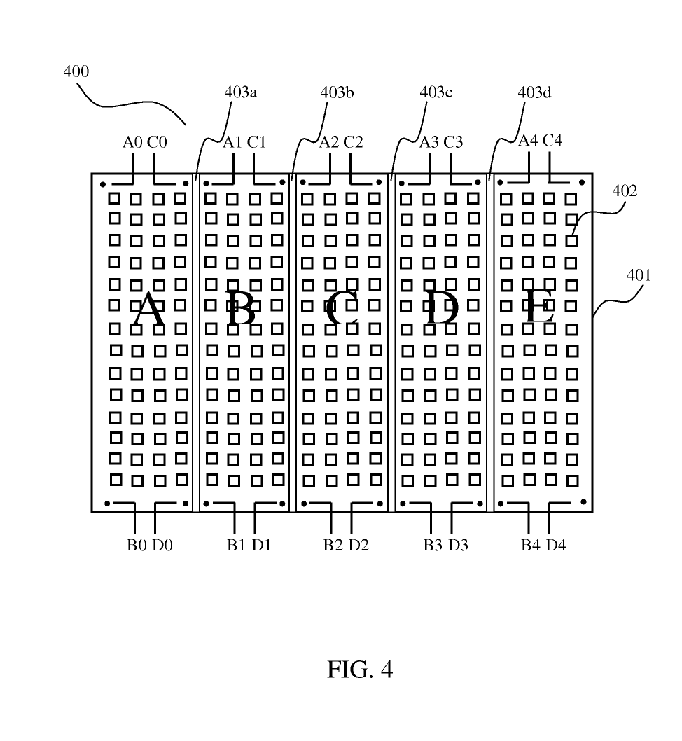

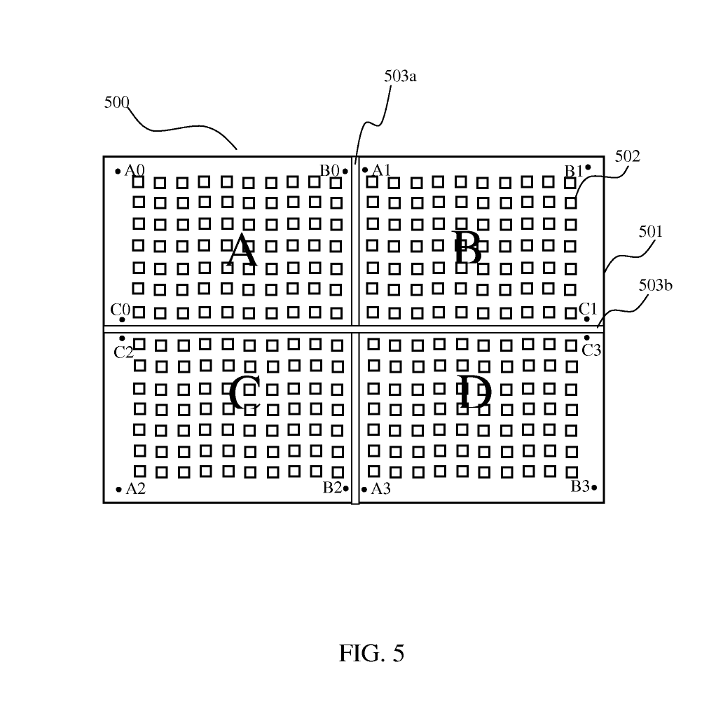

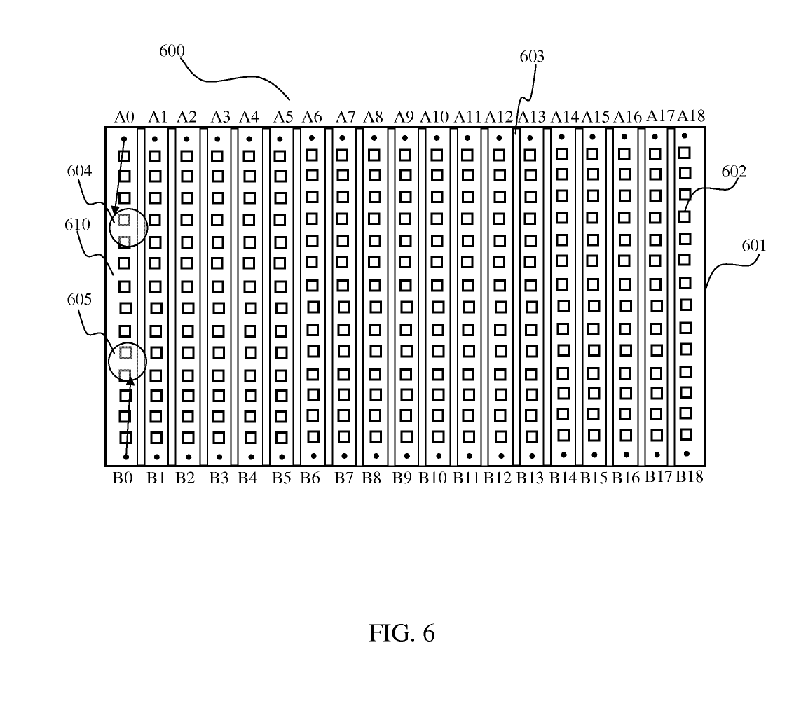

In one embodiment, the single touch-sensing layer of a capacitive touch panel can be divided into N separate blocks by (N−1) parallel slits formed on the touch-sensing layer. With reference to FIG. 4, a top view of a single-layer capacitive touch panel 400 with a first type of panel partition for multi-point sensing according to a first embodiment of the present invention is schematically illustrated. In the embodiment, the capacitive touch panel 400 comprises a single touch-sensing layer 401 that is divided into five blocks A, B, C, D, E separated by four parallel slits 403a, 403b, 403c, 403d. The slits 403a, 403b, 403c, 403d can be generated together with the etched out squares 402 on the touch-sensing layer 401 in the etching process. For each of the five blocks A, B, C, D, E, four detecting points respectively positioned at four corners of the block are kept scanning by applying asynchronous clock signals to realize two-point sensing in the block. As a result, the entire capacitive touch panel consisting of the five blocks A, B, C, D, E can simultaneously detect ten touch points on the capacitive touch panel 400. It can be easily appreciated that a variety of partition patterns can be applied to the capacitive touch panel to realize multi-point sensing. Herein, the blocks on the capacitive touch panel can have different sizes, but they are preferably configured to have a same size for simplifying both the fabrication process and the design of controller. Even though it is required to partition a capacitive touch panel into blocks of a same size, there are various types of partition. For example, FIG. 5 and FIG. 6 depict two possible partitions different from that illustrated with reference to FIG. 4. As described below, the different partitions may result in different settings of the detecting points on the capacitive touch panel.

In another embodiment, the single touch-sensing layer of a capacitive touch panel can be divided into N separate block by N/2 slits. For instance, referring to FIG. 5, two slits 503a, 503b perpendicularly intersects and divides the touch-sensing layer 501 of the capacitive touch panel 500 into four blocks A, B, C, D. Similar to the touch panel in FIG. 4, the two slits 503a, 503b and the etched out square regions 502 can be simultaneously formed in a same etching process. As shown in FIG. 5, for each block of the touch-sensing layer 501, only three detecting points respectively positioned at three corners of the block will be connected to the controller of the touch panel for detecting a single touch point in the block at a same time. For instance, block A has four corners, one of which is at the crossing point of the two slits 503a, 503b and has no detecting point positioned, while the detecting points A0, B0, C0 are respectively positioned at the other three corners of block A to accomplish one-point sensing in block A. Although each block can only detect a single touch point at a same time, the entire capacitive touch panel consisting of the four blocks A, B, C, D can simultaneously detect at least four touch points on the capacitive touch panel 500.

Another partition pattern of a capacitive touch panel will be demonstrated by referring to FIG. 6. As shown in the figure, the touch-sensing layer 601 of the capacitive touch panel 600 is divided into a lot of longitudinal bars by a number of parallel slits 603. Actually, the partition pattern illustrated in FIG. 6 is the same as the partition pattern illustrated in FIG. 4, but in this embodiment, the dimension of each longitudinal bar in the horizontal direction has been made smaller than the desired resolution (e.g. the dimension of human's finger in the horizontal direction), therefore only one-dimension detection in the vertical direction can determine the position of a touch on the capacitive touch panel 600. In other words, the coordinate of a touch point in the horizontal direction can be determined in the controller by simply identifying which longitudinal bar the signal change caused by touching at the touch point comes from. Thus, only two detecting points respectively positioned at the two ends of each longitudinal bar need to be scanned to calculate the coordinate of the touch point in the vertical direction. As shown in the figure, the touch-sensing layer 601 of the capacitive touch panel 600 is processed in an etching process to generate a patterned touch-sensing layer 601 with the etched out square regions 602, and then divided into a lot of longitudinal bars by a number of parallel slits 603. The number of parallel slits 603 and the etched out square regions 602 can be simultaneously formed in a same etching process. Alternatively, since the determination of a touch position has become a simple one-direction detection, the etch process for forming a pattern on the touch-sensing layer 601 (i.e. etching out the square regions 602) can be omitted and only the number of parallel slits are formed to divide the touch-sensing layer 601 into narrow longitudinal bars. For instance, there are two finger touches at touch points 604, 605 simultaneously occurring on the longitudinal bar 610. Two detecting points A0, B0 at the ends of the longitudinal bar 610 are scanned and connected to a controller, wherein the detecting point A0 is responsible for detecting the first touch point 604 that is close to the detecting point A0 and the other detecting point B0 assists the detection of the first touch point 604; and likewise, the detecting point B0 is responsible for detecting the second touch point 605 that is close to the detecting point B0, and the other detecting point A0 assist the detection of the second touch point 605. In this way, the simultaneous detection of two touch points in the longitudinal bar 610 can be accomplished, and thereby totally 38 touch points on the capacitive touch panel 600 can be simultaneously detected since the capacitive touch panel 600 consists of totally 19 longitudinal bars. In the embodiment, the touch-sensing layer 601 is divided into longitudinal bars. However, it is obvious that the touch-sensing layer 601 can also be divided into horizontal bars and similarly, only two detecting points respectively positioned at the two ends of each horizontal bar need to be scanned to calculate the coordinate of a touch point in the horizontal direction.

The foregoing description provides an implement disclosure of the invention, which is not limited by the detailed description but only by the scope of the appended claims. All those other aspects of the invention that will become apparent to a person of skill in the art, who has read the foregoing, are within the scope of the invention and of the following claims.

1. A single-layer capacitive touch panel for multi-point sensing, comprising:
a controller;
a single touch-sensing layer having a predetermined pattern formed on the touch-sensing layer;
four detecting points respectively disposed at four corners of the single touch-sensing layer; and
four sensing traces for respectively connecting the four detecting points to the controller, wherein
the four detecting points are configured to detect at least two touches that simultaneously occur on the single touch-sensing layer;
the four sensing traces respectively transmit signal changes at the four detecting points caused by the at least two touches to the controller; and
the controller is configured to determine positions of the at least two touches in accordance with the signal changes at the four detecting points.

2. The single-layer capacitive touch panel for multi-point sensing as recited in claim 1, wherein
asynchronous clock signals are applied to successively scan the signal changes at the four detecting points over a predefined period of time.

3. The single-layer capacitive touch panel for multi-point sensing as recited in claim 1, wherein
when a touch occurs at a touch point on the single touch-sensing layer, a unique signaling path with high resistance determined by the predetermined pattern on the single touch-sensing layer is built up between the touch point and each of the four detecting points.

4. The single-layer capacitive touch panel for multi-point sensing as recited in claim 1, wherein the single touch-sensing layer is a transparent Indium tin oxide (ITO) layer.

5. The single-layer capacitive touch panel for multi-point sensing as recited in claim 1, wherein the predetermined pattern is formed on the single touch-sensing layer in an etching process by using a predetermined mask.

6. The single-layer capacitive touch panel for multi-point sensing as recited in claim 1, wherein
the single touch-sensing layer is divided into N separate blocks by forming (N−1) parallel slits on the single touch-sensing layer, wherein N is an integral number greater than 1;
for each block of the single touch-sensing layer,
four detecting points are disposed at four corners of the block of the single touch-sensing layer respectively and configured to detect at least two touches that simultaneously occur on the block of the single touch-sensing layer; and
four sensing traces are provided for respectively transmitting signal changes at the four detecting points caused by the at least two touches on the block of the single touch-sensing layer to the controller; and
the controller is configured to determine positions of the at least two touches on each of the N separate blocks in accordance with the signal changes at the four detecting points on the block and totally determine positions of 2N touches that occur on the single touch-sensing layer at a same time.

7. The single-layer capacitive touch panel for multi-point sensing as recited in claim 6, wherein
for each block of the single touch-sensing layer, asynchronous clock signals are applied to successively scan the signal changes at the four detecting points on the block over a predefined period of time.

8. The single-layer capacitive touch panel for multi-point sensing as recited in claim 6, wherein
for each block of the single touch-sensing layer, when a touch occurs at a touch point on the block, a unique signaling path with high resistance determined by the predetermined pattern on the single touch-sensing layer is built up between the touch point and each of the four detecting points on the block.

9. The single-layer capacitive touch panel for multi-point sensing as recited in claim 6, wherein the (N−1) parallel slits and the predetermined pattern on the single touch-sensing layer are simultaneously formed in a same etching process.

10. The single-layer capacitive touch panel for multi-point sensing as recited in claim 1, wherein
the single touch-sensing layer is divided into N separate blocks by forming N/2 slits on the single touch-sensing layer, wherein N is an integral number greater than 1, and (N/2−1) slits of the N/2 slits are parallel to each other and perpendicularly intersected with one slit other than the (N/2−1) slits of the N/2 slits;
for each block of the single touch-sensing layer,
three detecting points are disposed at three corners of the block of the single touch-sensing layer respectively and configured to detect at least one touch that occurs on the block of the single touch-sensing layer; and
three sensing traces are provided for respectively transmitting signal changes at the three detecting points caused by the at least one touch on the block of the single touch-sensing layer to the controller; and
the controller is configured to determine a position of the at least one touch on each of the N separate blocks in accordance with the signal changes at the three detecting points on the block and totally determine positions of N touches that occur on the single touch-sensing layer at a same time.

11. The single-layer capacitive touch panel for multi-point sensing as recited in claim 10, wherein the N/2 slits and the predetermined pattern on the single touch-sensing layer are simultaneously formed in a same etching process.

12. The single-layer capacitive touch panel for multi-point sensing as recited in claim 1, wherein
the single touch-sensing layer is divided into N separate bars by forming (N−1) parallel slits on the single touch-sensing layer, wherein N is an integral number greater than 1;
a dimension of each bar in a direction perpendicular to the (N−1) parallel slits is configured to be smaller than a resolution desired for detecting a touch on the single-layer capacitive touch panel;
for each bar of the single touch-sensing layer,
two detecting points are disposed at two ends of the bar of the single touch-sensing layer respectively and configured to detect at least two touches that simultaneously occur on the bar of the single touch-sensing layer; and
two sensing traces are provided for respectively transmitting signal changes at the two detecting points caused by the at least two touches on the bar of the single touch-sensing layer to the controller; and
the controller is configured to determine positions of the at least two touches on each of the N separate bars in accordance with the signal changes at the two detecting points on the bar and totally determine positions of 2N touches that occur on the single touch-sensing layer at a same time.

13. The single-layer capacitive touch panel for multi-point sensing as recited in claim 12, wherein
for each bar of the single touch-sensing layer, asynchronous clock signals are applied to successively scan the signal changes at the two detecting points over a predefined period of time.

14. The single-layer capacitive touch panel for multi-point sensing as recited in claim 12, wherein the (N−1) parallel slits and the predetermined pattern on the single touch-sensing layer are simultaneously formed in a same etching process.

15. A single-layer capacitive touch panel for multi-point sensing, comprising:
a controller; and
a single touch-sensing layer that is divided into N separate bars by forming (N−1) parallel slits, wherein N is an integral number greater than 1, wherein
a dimension of each bar in a direction perpendicular to the (N−1) parallel slits is configured to be smaller than a resolution desired for detecting a touch on the single-layer capacitive touch panel;
for each bar of the single touch-sensing layer,
two detecting points are disposed at two ends of the bar of the single touch-sensing layer respectively and configured to detect at least two touches that simultaneously occur on the bar of the single touch-sensing layer;
two sensing traces are provided for respectively transmitting signal changes at the two detecting points caused by the at least two touches on the bar of the single touch-sensing layer to the controller; and
the controller is configured to determine positions of the at least two touches on each of the N separate bars in accordance with the signal changes at the two detecting points on the bar and totally determine positions of 2N touches that occur on the single touch-sensing layer at a same time.

16. The single-layer capacitive touch panel for multi-point sensing as recited in claim 15, wherein
for each bar of the single touch-sensing layer, asynchronous clock signals are applied to successively scan the signal changes at the two detecting points on the bar over a predefined period of time.

17. The single-layer capacitive touch panel for multi-point sensing as recited in claim 15, wherein the single touch-sensing layer is a transparent Indium tin oxide (ITO) layer.

18. A single-layer capacitive touch panel for multi-point sensing, comprising:
a controller;
a single touch-sensing layer having a predetermined pattern formed on the touch-sensing layer;
four detecting points respectively disposed at four corners of the single touch-sensing layer; and
four sensing traces for respectively connecting the four detecting points to the controller, wherein
the four detecting points are configured to detect at least two touches that simultaneously occur on the single touch-sensing layer;
when a touch occurs at a touch point on the single touch-sensing layer, a unique signaling path with high resistance determined by the predetermined pattern on the single touch-sensing layer is built up between the touch point and each of the four detecting points;
asynchronous clock signals are applied to successively scan the signal changes at the four detecting points over a predefined period of time;
the four sensing traces respectively transmit signal changes at the four detecting points caused by the at least two touches to the controller; and
the controller is configured to determine positions of the at least two touches in accordance with the signal changes at the four detecting points.

19. The single-layer capacitive touch panel for multi-point sensing as recited in claim 18, wherein the single touch-sensing layer is a transparent Indium tin oxide (ITO) layer.

20. The single-layer capacitive touch panel for multi-point sensing as recited in claim 18, wherein the predetermined pattern is formed on the single touch-sensing layer in an etching process by using a predetermined mask.
